(19) United States
(12) Patent Application Publication
(10) Pub. No.: US 2015/0071257 A1
(43) Pub. Date: Mar. 12, 2015

(54) RADIO RESOURCE REQUEST FOR IRAT MEASUREMENT IN TD-HSUPA/TD-HSDPA

(71) Applicant: QUALCOMM Incorporated, San Diego, CA (US)

(72) Inventors: Ming YANG, San Diego, CA (US); Tom CHIN, San Diego, CA (US); Guangming SHI, San Diego, CA (US)

(73) Assignee: QUALCOMM Incorporated, San Diego, CA (US)

(21) Appl. No.: 14/023,260

(22) Filed: Sep. 10, 2013

(51) Int. Cl. H04W 72/04

(52) U.S. Cl. CPC H04W 72/0413
USPC 370/336; 370/329

(57) ABSTRACT

A user equipment (UE) may achieve fast inter radio access technology (IRAT) measurement and better IRAT handover performance to effectively avoid call drops via smooth IRAT handover to other RATs during Time Division High Speed Downlink/Uplink Packet Access (TD-HSDPA/TD-HSUPA) data transmission. In some instances, the UE may speed up the IRAT measurement by request a resource allocation grant preference from a base station. The request indicates a reduced number of time resources and an increased number of other resources.

### BACKGROUND

1. Field

Aspects of the present disclosure relate generally to wireless communication systems, and more particularly, to radio resource request for inter radio access technology (IRAT) in Time Division High Speed Downlink Packet Access (TD-HSDPA) and Time Division High Speed Uplink Packet Access (TD-HSUPA) networks.

2. Background

Wireless communication networks are widely deployed to provide various communication services such as telephony, video, data, messaging, broadcasts, and so on. Such networks, which are usually multiple access networks, support communications for multiple users by sharing the available network resources. One example of such a network is the Universal Terrestrial Radio Access Network (UTRAN). The UTRAN is the radio access network (RAN) defined as a part of the Universal Mobile Telecommunications System (UMTS), a third generation (3G) mobile phone technology supported by the 3rd Generation Partnership Project (3GPP). The UMTS, which is the successor to Global System for Mobile Communications (GSM) technologies, currently supports various air interface standards, such as Wideband-Code Division Multiple Access (W-CDMA), Time Division-Code Division Multiple Access (TD-CDMA), and Time Division-Synchronous Code Division Multiple Access (TD-SCDMA). For example, China is pursuing TD-SCDMA as the underlying air interface in the UTRAN architecture with its existing GSM infrastructure as the core network. The UMTS also supports enhanced 3G data communications protocols, such as High Speed Packet Access (HSPA), which provides higher data transfer speeds and capacity to associated UMTS networks. HSPA is a collection of two mobile telephony protocols, High Speed Downlink Packet Access (HSDPA) and High Speed Uplink Packet Access (HSUPA) that extends and improves the performance of existing wideband protocols.

As the demand for mobile broadband access continues to increase, research and development continue to advance the UMTS technologies not only to meet the growing demand for mobile broadband access, but to advance and enhance the user experience with mobile communications.

### SUMMARY

According to one aspect of the present disclosure, a method for wireless communication includes requesting a resource allocation grant preference from a base station, the request indicating a reduced number of time resources and an increased number of other resources.

According to another aspect of the present disclosure, an apparatus for wireless communication includes means for requesting a resource allocation grant preference from a base station, the request indicating a reduced number of time resources and an increased number of other resources. The apparatus may also include means for communicating based on the resource allocation grant preference.

According to one aspect of the present disclosure, a computer program product for wireless communication in a wireless network includes a computer readable medium having non-transitory program code recorded thereon. The program code includes program code to request a resource allocation grant preference from a base station, the request indicating a reduced number of time resources and an increased number of other resources.

According to one aspect of the present disclosure, an apparatus for wireless communication includes a memory and a processor(s) coupled to the memory. The processor(s) is configured to request a resource allocation grant preference from a base station, the request indicating a reduced number of time resources and an increased number of other resources.

This has outlined, rather broadly, the features and technical advantages of the present disclosure in order that the detailed description that follows may be better understood. Additional features and advantages of the disclosure will be described below. It should be appreciated by those skilled in the art that this disclosure may be readily utilized as a basis for modifying or designing other structures for carrying out the same purposes of the present disclosure. It should also be realized by those skilled in the art that such equivalent constructions do not depart from the teachings of the disclosure as set forth in the appended claims. The novel features, which are believed to be characteristic of the disclosure, both as to its organization and method of operation, together with further objects and advantages, will be better understood from the following description when considered in connection with the accompanying figures. It is to be expressly understood, however, that each of the figures is provided for the purpose of illustration and description only and is not intended as a definition of the limits of the present disclosure.

### BRIEF DESCRIPTION OF THE DRAWINGS

The features, nature, and advantages of the present disclosure will become more apparent from the detailed description set forth below when taken in conjunction with the drawings in which like reference characters identify correspondingly throughout.

FIG. 1 is a block diagram conceptually illustrating an example of a telecommunications system.

FIG. 2 is a block diagram conceptually illustrating an example of a frame structure in a telecommunications system.

FIG. 3 is a block diagram conceptually illustrating an example of a node B in communication with a UE in a telecommunications system.

FIGS. 4A and 4B illustrate flexible allocation of radio resources by a scheduler of a base station according to some aspects of the present disclosure.

FIG. 5 is a block diagram illustrating a radio resource request method according to one aspect of the present disclosure.

FIG. 6 is a diagram illustrating an example of a hardware implementation for an apparatus employing a processing system according to one aspect of the present disclosure.

### DETAILED DESCRIPTION

The detailed description set forth below, in connection with the appended drawings, is intended as a description of various configurations and is not intended to represent the only configurations in which the concepts described herein may be practiced. The detailed description includes specific details for the purpose of providing a thorough understanding of the various concepts. However, it will be apparent to those skilled in the art that these concepts may be practiced without these specific details. In some instances, well-known structures and components are shown in block diagram form in order to avoid obscuring such concepts.

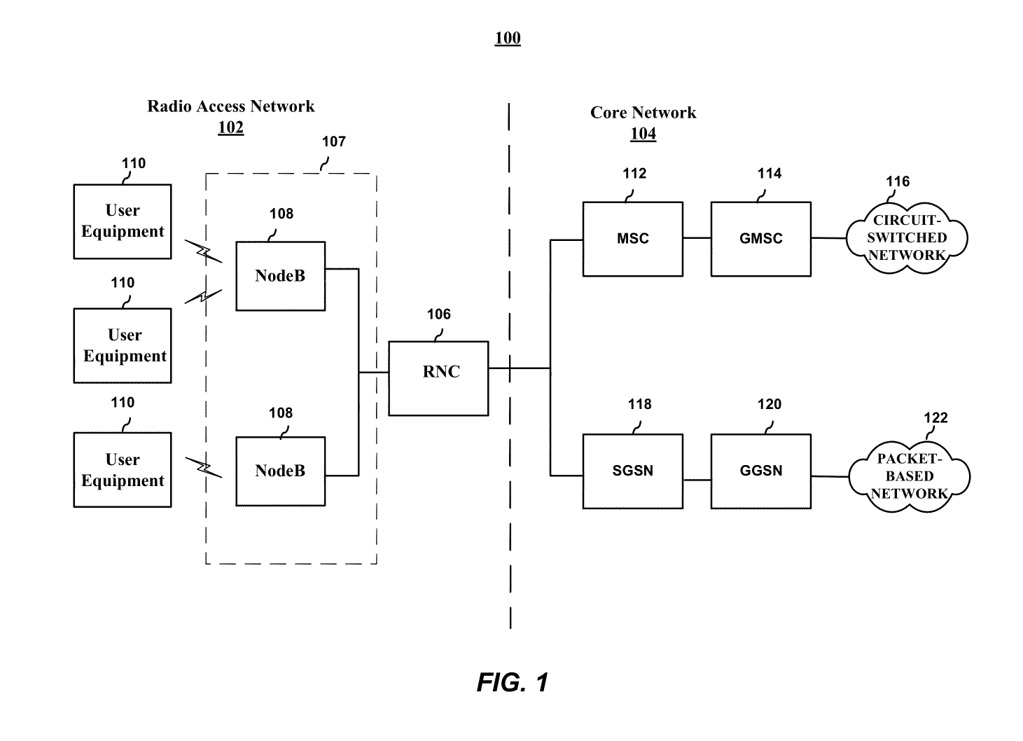

Turning now to FIG. 1, a block diagram is shown illustrating an example of a telecommunications system 100. The various concepts presented throughout this disclosure may be implemented across a broad variety of telecommunication systems, network architectures, and communication standards. By way of example and without limitation, the aspects of the present disclosure illustrated in FIG. 1 are presented with reference to a UMTS system employing a TD-SCDMA standard. In this example, the UMTS system includes a (radio access network) RAN 102 (e.g., UTRAN) that provides various wireless services including telephony, video, data, messaging, broadcasts, and/or other services. The RAN 102 may be divided into a number of Radio Network Subsystems (RNSs) such as an RNS 107, each controlled by a Radio Network Controller (RNC) such as an RNC 106. For clarity, only the RNC 106 and the RNS 107 are shown; however, the RAN 102 may include any number of RNCs and RNSs in addition to the RNC 106 and RNS 107. The RNC 106 is an apparatus responsible for, among other things, assigning, reconfiguring and releasing radio resources within the RNS 107. The RNC 106 may be interconnected to other RNCs (not shown) in the RAN 102 through various types of interfaces such as a direct physical connection, a virtual network, or the like, using any suitable transport network.

The geographic region covered by the RNS 107 may be divided into a number of cells, with a radio transceiver apparatus serving each cell. A radio transceiver apparatus is commonly referred to as a node B in UMTS applications, but may also be referred to by those skilled in the art as a base station (BS), a base transceiver station (BTS), a radio base station, a radio transceiver, a transceiver function, a basic service set (BSS), an extended service set (ESS), an access point (AP), or some other suitable terminology. For clarity, two node Bs 108 are shown; however, the RNS 107 may include any number of wireless node Bs. The node Bs 108 provide wireless access points to a core network 104 for any number of mobile apparatuses. Examples of a mobile apparatus include a cellular phone, a smart phone, a session initiation protocol (SIP) phone, a laptop, a notebook, a netbook, a smartbook, a personal digital assistant (PDA), a satellite radio, a global positioning system (GPS) device, a multimedia device, a video device, a digital audio player (e.g., MP3 player), a camera, a game console, or any other similar functioning device. The mobile apparatus is commonly referred to as user equipment (UE) in UMTS applications, but may also be referred to by those skilled in the art as a mobile station (MS), a subscriber station, a mobile unit, a subscriber unit, a wireless unit, a remote unit, a mobile device, a wireless device, a wireless communications device, a remote device, a mobile subscriber station, an access terminal (AT), a mobile terminal, a wireless terminal, a remote terminal, a handset, a terminal, a user agent, a mobile client, a client, or some other suitable terminology. For illustrative purposes, three UEs 110 are shown in communication with the node Bs 108. The downlink (DL), also called the forward link, refers to the communication link from a node B to a UE, and the uplink (UL), also called the reverse link, refers to the communication link from a UE to a node B.

The core network 104, as shown, includes a GSM core network. However, as those skilled in the art will recognize, the various concepts presented throughout this disclosure may be implemented in a RAN, or other suitable access network, to provide UEs with access to types of core networks other than GSM networks.

In this example, the core network 104 supports circuit-switched services with a mobile switching center (MSC) 112 and a gateway MSC (GMSC) 114. One or more RNCs, such as the RNC 106, may be connected to the MSC 112. The MSC 112 is an apparatus that controls call setup, call routing, and UE mobility functions. The MSC 112 also includes a visitor location register (VLR) (not shown) that contains subscriber-related information for the duration that a UE is in the coverage area of the MSC 112. The GMSC 114 provides a gateway through the MSC 112 for the UE to access a circuit-switched network 116. The GMSC 114 includes a home location register (HLR) (not shown) containing subscriber data, such as the data reflecting the details of the services to which a particular user has subscribed. The HLR is also associated with an authentication center (AuC) that contains subscriber-specific authentication data. When a call is received for a particular UE, the GMSC 114 queries the HLR to determine the UE's location and forwards the call to the particular MSC serving that location.

The core network 104 also supports packet-data services with a serving GPRS support node (SGSN) 118 and a gateway GPRS support node (GGSN) 120. GPRS, which stands for General Packet Radio Service, is designed to provide packet-data services at speeds higher than those available with standard GSM circuit-switched data services. The GGSN 120 provides a connection for the RAN 102 to a packet-based network 122. The packet-based network 122 may be the Internet, a private data network, or some other suitable packet-based network. The primary function of the GGSN 120 is to provide the UEs 110 with packet-based network connectivity. Data packets are transferred between the GGSN 120 and the UEs 110 through the SGSN 118, which performs primarily the same functions in the packet-based domain as the MSC 112 performs in the circuit-switched domain.

The UMTS air interface is a spread spectrum Direct-Sequence Code Division Multiple Access (DS-CDMA) system. The spread spectrum DS-CDMA spreads user data over a much wider bandwidth through multiplication by a sequence of pseudorandom bits called chips. The TD-SCDMA standard is based on such direct sequence spread spectrum technology and additionally calls for a time division duplexing (TDD), rather than a frequency division duplexing (FDD) as used in many FDD mode UMTS/W-CDMA systems. TDD uses the same carrier frequency for both the uplink (UL) and downlink (DL) between a node B 108 and a UE 110, but divides uplink and downlink transmissions into different time slots in the carrier.

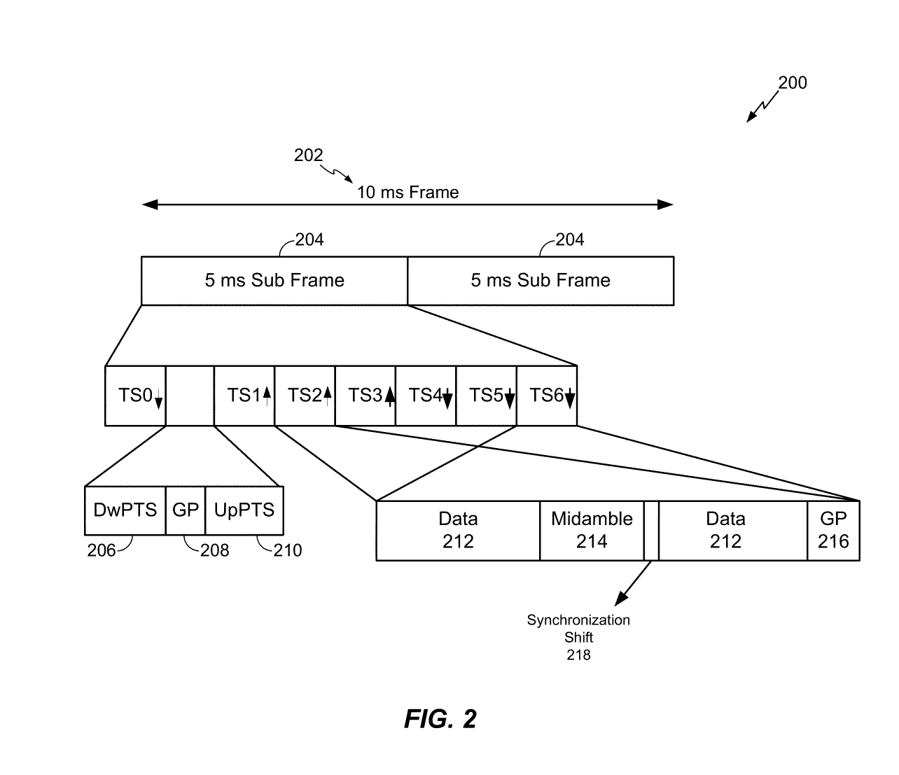

FIG. 2 shows a frame structure 200 for a TD-SCDMA carrier. The TD-SCDMA carrier, as illustrated, has a frame 202 that is 10 ms in length. The chip rate in TD-SCDMA is 1.28 Mcps. The frame 202 has two 5 ms subframes 204, and each of the subframes 204 includes seven time slots, TS0 through TS6. The first time slot, TS0, is usually allocated for downlink communication, while the second time slot, TS1, is usually allocated for uplink communication. The remaining time slots, TS2 through TS6, may be used for either uplink or downlink, which allows for greater flexibility during times of higher data transmission times in either the uplink or downlink directions. A downlink pilot time slot (DwPTS) 206, a guard period (GP) 208, and an uplink pilot time slot (UpPTS) 210 (also known as the uplink pilot channel (UpPCH)) are located between TS0 and TS1. Each time slot, TS0-TS6, may allow data transmission multiplexed on a maximum of 16 code channels. Data transmission on a code channel includes two data portions 212 (each with a length of 352 chips) separated by a midamble 214 (with a length of 144 chips) and followed by a guard period (GP) 216 (with a length of 16 chips). The midamble 214 may be used for features, such as channel estimation, while the guard period 216 may be used to avoid inter-burst interference. Also transmitted in the data portion is some Layer 1 control information, including Synchronization Shift (SS) bits 218. Synchronization Shift bits 218 only appear in the second part of the data portion. The Synchronization Shift bits 218 immediately following the midamble can indicate three cases: decrease shift, increase shift, or do nothing in the upload transmit timing. The positions of the SS bits 218 are not generally used during uplink communications.

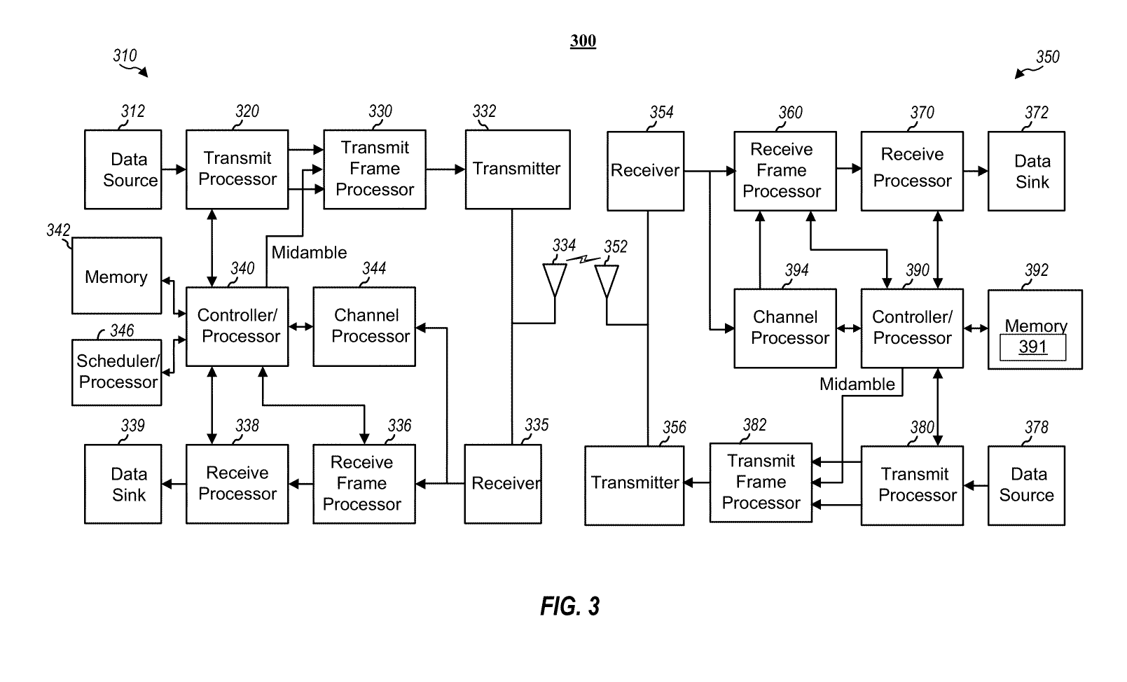

FIG. 3 is a block diagram of a node B 310 in communication with a UE 350 in a RAN 300, where the RAN 300 may be the RAN 102 in FIG. 1, the node B 310 may be the node B 108 in FIG. 1, and the UE 350 may be the UE 110 in FIG. 1. In the downlink communication, a transmit processor 320 may receive data from a data source 312 and control signals from a controller/processor 340. The transmit processor 320 provides various signal processing functions for the data and control signals, as well as reference signals (e.g., pilot signals). For example, the transmit processor 320 may provide cyclic redundancy check (CRC) codes for error detection, coding and interleaving to facilitate forward error correction (FEC), mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM), and the like), spreading with orthogonal variable spreading factors (OVSF), and multiplying with scrambling codes to produce a series of symbols. Channel estimates from a channel processor 344 may be used by a controller/processor 340 to determine the coding, modulation, spreading, and/or scrambling schemes for the transmit processor 320. These channel estimates may be derived from a reference signal transmitted by the UE 350 or from feedback contained in the midamble 214 (FIG. 2) from the UE 350. The symbols generated by the transmit processor 320 are provided to a transmit frame processor 330 to create a frame structure. The transmit frame processor 330 creates this frame structure by multiplexing the symbols with a midamble 214 (FIG. 2) from the controller/processor 340, resulting in a series of frames. The frames are then provided to a transmitter 332, which provides various signal conditioning functions including amplifying, filtering, and modulating the frames onto a carrier for downlink transmission over the wireless medium through smart antennas 334. The smart antennas 334 may be implemented with beam steering bidirectional adaptive antenna arrays or other similar beam technologies.

At the UE 350, a receiver 354 receives the downlink transmission through an antenna 352 and processes the transmission to recover the information modulated onto the carrier. The information recovered by the receiver 354 is provided to a receive frame processor 360, which parses each frame, and provides the midamble 214 (FIG. 2) to a channel processor 394 and the data, control, and reference signals to a receive processor 370. The receive processor 370 then performs the inverse of the processing performed by the transmit processor 320 in the node B 310. More specifically, the receive processor 370 descrambles and despreads the symbols, and then determines the most likely signal constellation points transmitted by the node B 310 based on the modulation scheme. These soft decisions may be based on channel estimates computed by the channel processor 394. The soft decisions are then decoded and deinterleaved to recover the data, control, and reference signals. The CRC codes are then checked to determine whether the frames were successfully decoded. The data carried by the successfully decoded frames will then be provided to a data sink 372, which represents applications running in the UE 350 and/or various user interfaces (e.g., display). Control signals carried by successfully decoded frames will be provided to a controller/processor 390. When frames are unsuccessfully decoded by the receiver processor 370, the controller/processor 390 may also use an acknowledgement (ACK) and/or negative acknowledgement (NACK) protocol to support retransmission requests for those frames.

In the uplink, data from a data source 378 and control signals from the controller/processor 390 are provided to a transmit processor 380. The data source 378 may represent applications running in the UE 350 and various user interfaces (e.g., keyboard). Similar to the functionality described in connection with the downlink transmission by the node B 310, the transmit processor 380 provides various signal processing functions including CRC codes, coding and interleaving to facilitate FEC, mapping to signal constellations, spreading with OVSFs, and scrambling to produce a series of symbols. Channel estimates, derived by the channel processor 394 from a reference signal transmitted by the node B 310 or from feedback contained in the midamble transmitted by the node B 310, may be used to select the appropriate coding, modulation, spreading, and/or scrambling schemes. The symbols produced by the transmit processor 380 will be provided to a transmit frame processor 382 to create a frame structure. The transmit frame processor 382 creates this frame structure by multiplexing the symbols with a midamble 214 (FIG. 2) from the controller/processor 390, resulting in a series of frames. The frames are then provided to a transmitter 356, which provides various signal conditioning functions including amplification, filtering, and modulating the frames onto a carrier for uplink transmission over the wireless medium through the antenna 352.

The uplink transmission is processed at the node B 310 in a manner similar to that described in connection with the receiver function at the UE 350. A receiver 335 receives the uplink transmission through the antenna 334 and processes the transmission to recover the information modulated onto the carrier. The information recovered by the receiver 335 is provided to a receive frame processor 336, which parses each frame, and provides the midamble 214 (FIG. 2) to the channel processor 344 and the data, control, and reference signals to a receive processor 338. The receive processor 338 performs the inverse of the processing performed by the transmit processor 380 in the UE 350. The data and control signals carried by the successfully decoded frames may then be provided to a data sink 339 and the controller/processor, respectively. If some of the frames were unsuccessfully decoded by the receive processor, the controller/processor 340 may also use an acknowledgement (ACK) and/or negative acknowledgement (NACK) protocol to support retransmission requests for those frames.

The controller/processors 340 and 390 may be used to direct the operation at the node B 310 and the UE 350, respectively. For example, the controller/processors 340 and 390 may provide various functions including timing, peripheral interfaces, voltage regulation, power management, and other control functions. The computer readable media of memories 342 and 392 may store data and software for the node B 310 and the UE 350, respectively. For example, the memory 392 of the UE 350 may store a radio resource request module 391 which, when executed by the controller/processor 390, configures the UE 350 for determining an expected synchronization channel code word based on the operating frequency and base station identification code of a base station. A scheduler/processor 346 at the node B 310 may be used to allocate resources to the UEs and schedule downlink and/or uplink transmissions for the UEs.

High speed downlink packet access (HSDPA) is an enhancement to TD-SCDMA, and is utilized to enhance downlink throughput. The TD-SCDMA HSDPA systems include physical channels such as, the high speed physical downlink shared channel (HS-PDSCH), high speed shared control channel (HS-SCCH) and high speed shared information channel (HS-SICH). The HS-PDSCH carries a user data burst.

The HS-SCCH carries the modulation and coding scheme for the data burst in HS-PDSCH. The HS-SCCH also carries the channelization code and time slot information for the data burst in HS-PDSCH as well as the UE identity to indicate which UE should receive the data burst allocation. The UE is allocated with some resources by the HS-SCCH before the UE can receive high speed data on HS-PDSCH. The HS-SCCH also carries HS-SCCH cyclic sequence number that increments UE specific cyclic sequence number for each HS-SCCH transmission. In addition, the HS-SCCH carries Hybrid Automatic Repeat reQuest (HARQ) process, redundancy version, and new data indicator information for the data burst. Further, the HS-SCCH indicates time slot allocation of a next subframe for the HS-PDSCH.

The HS-SICH carries the channel quality indicator (CQI) which includes the recommended transport block size (RTBS) and the recommended modulation format (RMF). The HS-SICH also carries HARQ acknowledgement indicator (ACK/NACK) of the HS-PDSCH transmission.

High speed uplink packet access (HSUPA) is an enhancement to TD-SCDMA, and is utilized to enhance uplink throughput. HSUPA introduces the following physical channels: enhanced uplink dedicated channel (E-DCH), E-DCH physical uplink channel (E-PUCH), E-DCH uplink control channel (E-UCCH), E-DCH random access uplink control channel (E-RUCCH), absolute grant channel for E-DCH (E-AGCH) and hybrid ARQ indication channel for E-DCH (E-HICH).

The E-DCH is a dedicated transport channel and may be utilized to enhance an existing dedicated channel (DCH) transport channel carrying data traffic. The E-PUCH carries E-DCH traffic and scheduling information (SI). The E-PUCH can be transmitted in burst fashion.

The E-UCCH carries Layer 1 information for E-DCH transmission. The transport block size may be 6 bits and the retransmission sequence number (RSN) may be 2 bits. In addition, the HARQ process ID may be 2 bits.

The E-UCCH is an uplink physical control channel and carries scheduling information (SI), including a scheduling request and the UE ID (i.e., enhanced radio network temporary identifier (E-RNTI).) The E-AGCH carries grants for E-PUCH transmission, such as the maximum allowable E-PUCH transmission power, time slots, and code channels. Additionally, the E-HICH carries HARQ ACK/NAK signals.

In TD-HSUPA, the transmission of scheduling information (SI) may consist of in-band and out-band. The in-band type may be included in a medium access control e-type protocol data unit (MAC-e PDU) on the E-PUCH. The data may be sent standalone or may piggyback onto a data packet. For out-band, the data may be sent on the E-RUCCH. The scheduling information may include information, such as the highest priority logical channel ID (HLID), the total E-DCH buffer status (TEBS), the highest priority logical channel buffer status (HLBS) and the UE power headroom (UPH).

The HLID field identifies the highest priority logical channel with available data. If multiple logical channels exist with the highest priority, the one corresponding to the highest buffer occupancy is reported.

The TEBS field identifies the total amount of data available across all logical channels for which reporting has been requested by the radio resource control (RRC). The TEBS field also indicates the amount of data (in number of bytes) that is available for transmission and retransmission in the radio link control (RLC) layer. When the medium access control (MAC) is connected to an acknowledge mode (AM) radio link control entity, the control protocol data units (PDUs) that are to be transmitted and RLC PDUs outside the RLC transmission window are also included in the TEBS. The RLC PDUs that have been transmitted, but not negatively acknowledged by the peer entity, are not included in the TEBS. The actual value of the TEBS transmitted is one of 31 values that are mapped to a range of a number of bytes (e.g., 5 mapping to 24<TEBS<32).

The HLBS field indicates the amount of data available from the logical channel identified by the HLID. The amount of data available is relative to the highest value of the buffer size range reported by the TEBS when the reported TEBS index is not 31, and relative to 50,000 bytes when the reported TEBS index is 31. The values taken by HLBS is one of 16 values that map to a range of percentage values (e.g., 2 maps to 6%<HLBS<8%)

The UPH field indicates the ratio of the maximum UE transmission power and the corresponding dedicated physical control channel (DPCCH) code power. Further, the path loss information reports the path loss ratio between the serving cells and the neighboring cells.

### Radio Resource Request for IRAT Measurement in TD-HSDPA/TD-HSUPA

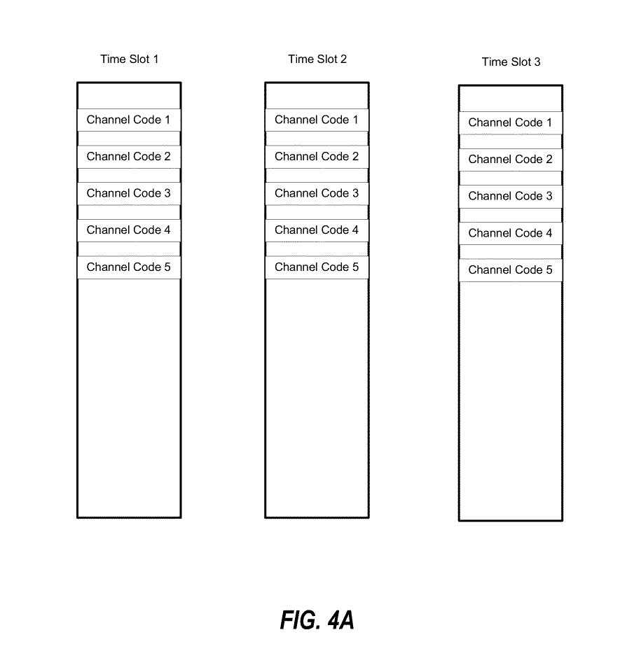

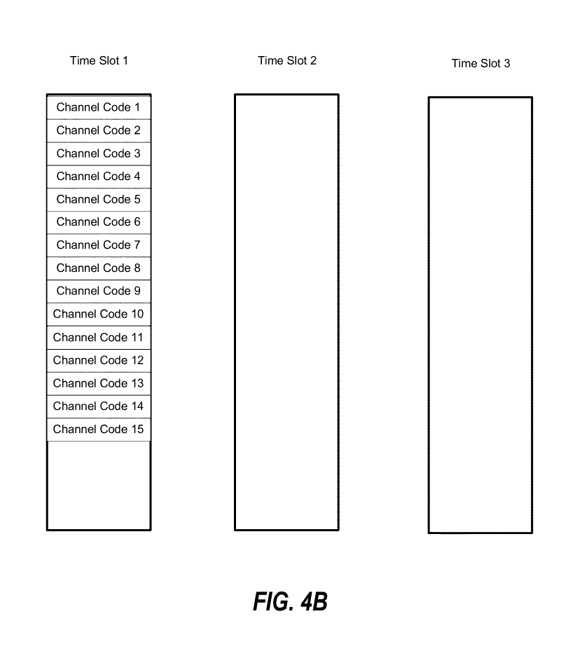

A communication system may include physical channels such as, downlink physical channels (e.g., high speed physical downlink shared channel (HS-PDSCH)) and uplink physical channels (e.g., enhanced uplink dedicated channel (E-DCH) physical uplink channel (E-PUCH)). A scheduler/processor of a Node B of the communication system may be used to allocate resources to the UEs. For example, the Node B determines radio resource for HS-PDSCH/E-PUCH transmissions for each sub-frame, in which the radio resource includes time slots and channel codes. The allocation of radio resources for some communication systems, (e.g., Time Division-Synchronous Code Division Multiple Access (TD-SCDMA)), may be flexible relative to other communication systems, (e.g., Wideband-Code Division Multiple Access (W-CDMA)). For example, in TD-SCDMA systems, in addition to allocating channel/channelization codes (e.g., Walsh code), the Node B also allocates time slots for transmission. Thus, the scheduler of the Node B of the TD-SCDMA system decides the number of channelization codes and the number of time slots to be used for a transmission. The flexible allocation of the radio resources is illustrated in FIGS. 4A and 4B.

FIG. 4A illustrates an example, where the scheduler allocates radio resources by utilizing three time slots (e.g., time slots 1, 2 and 3) and five channel codes (e.g., channel codes, 1, 2, 3, 4 and 5) for each time slot. Alternatively, in another example illustrated in FIG. 4B, the scheduler allocates one time slot (e.g., time slot 1) and fifteen channel codes (e.g., channel codes 1-15) for an allocated or granted time slot (e.g., time slot 1). The remaining time slots (e.g., time slots 2 and 3) may be idle time slots.

In addition to allocating time slots for HS-PDSCH transmissions, idle time slots may also be used for inter radio access technology (IRAT) measurements. For example, the IRAT measurements are performed during the idle time slots, (i.e., time slots that are not used for uplink or downlink communications). The idle time slots may be utilized for GSM/GPRS (global system for mobiles/general packet radio service) measurement(s) when a UE is leaving TD-SCDMA coverage during high speed downlink/uplink packet access (HSDPA/HSUPA) transmissions. The measurement(s) may include a TD-SCDMA serving cell signal strength, such as a received signal code power (RSCP) for a pilot channel (e.g., primary common control physical channel (P-CCPCH)).

The IRAT measurements may be performed, for example, when there is limited coverage of TD-SCDMA or when a UE desires a better RAT for a higher data rate during transmission. The UE may send, to a serving cell, a measurement report indicating results of the IRAT measurement performed by the UE. The serving cell may then trigger a handover of the UE to a new cell in another RAT based on the measurement report. The triggering may be based on a comparison between IRAT measurements of different RATs. The IRAT measurements may include a TD-SCDMA serving cell signal quality such as signal strength. The signal strength may include a received signal code power (RSCP) for a pilot channel (e.g., primary common control physical channel (P-CCPCH)), downlink signal to noise ratio (SNR)/signal-to-interference plus noise ratio (SINR) or other suitable metrics. The serving cell signal quality (e.g., signal strength) is compared to a predefined threshold, such as a serving system threshold. In one aspect, the serving system threshold is indicated to the UE through dedicated radio resource control (RRC) signaling from the network. The IRAT measurements may also include a GSM neighbor cell signal quality such as received signal strength indicator (RSSI) or other suitable metrics. The neighbor cell signal strength may be compared with a neighbor system threshold. Before handover or cell reselection, in addition to the measurement processes, the base station IDs (e.g., BSICs) may be confirmed and re-confirmed.

When the UE is performing IRAT measurements in preparation to leave a TD-SCDMA coverage (i.e., in preparation for handover) during HSDPA, the UE may not have sufficient idle time slots to perform the IRAT measurements. For example, when performing IRAT measurements for a TD-SCDMA to GSM handover, the UE may not have sufficient idle time slots to confirm and re-confirm a base station identity code (BSIC) of a neighboring GSM base station. Insufficient idle time slots for IRAT measurement may result in a degraded IRAT handover performance.

Various aspects of the present disclosure are directed to methods and systems of time slot allocation. In particular, various aspects of the present disclosure are directed to efficient use of idle time slots to improve handover performance when the UE is leaving TD-SCDMA coverage during HSDPA/HSUPA. In one aspect of the present disclosure, when the IRAT measurement of a metric of the TD-SCDMA serving cell fails to meet the predefined threshold, the UE can send a request for a resource allocation grant preference. The resource allocation grant preference may include a request for a reduced number of time resources and an increased number of other resources. An examples of other resources may include, but is not limited to, channel codes, frequency bandwidth within subcarriers, and/or transmit power resources. Further, aspects of the present disclosure may include a downlink implementation and an uplink implementation.

In some downlink implementations, five (5) bits carried in the high speed shared control channel (HS-SCCH) indicate the time slots scheduled for HS-PDSCH transmission. An 8-bit channelization code set specifies the set of channel codes, (e.g., 16 SF16 codes), for transmission. The HS-PDSCH channelization/channel codes are allocated contiguously from a signalled start code to a signalled stop code. The allocation includes both the start and stop code where the lower 4 bits of the channel codes represent the high speed starting code, and the higher 4 bits represent the end (stop) code.

In one aspect of a downlink implementation, the resource allocation grant preference may correspond to a request for less time slots and more channel codes through the HS-SICH. For example, the UE may send the request when a signal quality is below a predefined threshold. For example, when the TD-SCDMA serving cell received signal code power (RSCP) for a primary common control physical channel (P-CCPCH) or downlink (DL) traffic time slots SNR/SINR are below the pre-define threshold. The request may be carried in a new bit of a feedback channel (e.g., HS-SICH), which carries the resource allocation grant preference. The size of the resource carrying the resource allocation grant preference may be one bit. In response to the request, the scheduler of the NodeB assign less time slots and more channel codes for the same HS-PDSCH transport block size. For example, the request may cause the scheduler to assign more channel codes on time slot 1, as illustrated in FIG. 4B, while freeing up other time slots, (e.g., idle time slots 2 and 3). Thus, more idle time slots are created to use for IRAT measurement. This feature results in fast IRAT measurement and better IRAT handover performance.

In the uplink implementation, when the UE is leaving TD-SCDMA coverage during HSUPA, the UE uses idle time slots to perform IRAT measurements of GSM neighbor cells, such as GSM RSSI, GSM FCCH tone detection and SCH BSIC confirmation and reconfirmation. Because the available TD-SCDMA time slots are unavailable or limited (for example, only two or three continuous time slots are typically available in a TD-SCDMA subframe), the UE has limited time to measure the GSM neighbor cells and/or may not complete a full measurement during the available time slots. Consequently, IRAT measurement may be delayed, resulting in IRAT handover failure. For example, the UE may not perform IRAT measurements until a call is dropped even when there are strong GSM cells available for handover.

In one aspect of an uplink implementation, the TD-SCDMA Node B scheduler grants radio resources for enhanced uplink dedicated channel (E-DCH) physical uplink channel (E-PUCH) transmission. In this aspect, a specified number of bits (e.g., 5 bits) of resource information, e.g. timeslot resource related information (TRRI), are carried in the E-AGCH. The E-AGCH carries grants that indicate the preferred resources to be scheduled for E-PUCH transmission. For example, the E-AGCH carries grants such as the maximum allowable E-PUCH transmission power, time slots (i.e., more or less time slots), channel codes and other metrics.

As noted, the radio resources may include time slots that correspond to time slot domain and channel codes that correspond to code domain allocated by the NodeB scheduler for the E-PUCH transmission. The scheduler is configured to flexibly allocate the time slots and channel codes in accordance with the uplink implementation. For example, the scheduler may allocate five channel codes for each of the three time slots to the UE or may assign 15 channel codes to a single time slot, as illustrated in FIGS. 4A and 4B.

In one aspect of the uplink implementation, when the IRAT measurement of a metric or signal quality of the TD-SCDMA serving cell fails to meet the predefined threshold, the UE may request less time slots and more channel codes. In particular, the UE may send the request through scheduling information (SI) in a schedule request channel (e.g., E-RUCCH) or a data channel (e.g., E-PUCH). Requesting less time slots and more channel codes may free up time slots for performing IRAT measurement(s). For example, the request for more channel codes and less time slots may correspond to increasing the number of channel codes in a single time slot, while freeing up other time slots for IRAT measurement as illustrated by FIGS. 4A and 4B.

In one aspect of the uplink implementation, the UE sends the request when the TD-SCDMA serving cell RSCP for a P-CCPCH or downlink traffic time slots SNR/SINR falls below the predefined threshold. The UE may also send the request when the uplink transmission power is above a predefined transmission power threshold. In one aspect, in response to the request, the scheduler of the NodeB assigns less time slots and more channel codes for the same transport block size, resulting in more idle time slots created for IRAT measurement without affecting TD-HSUPA throughput.

In one aspect of the present disclosure, the UE may decide whether to use all or some of the radio resources allocated to the UE by the scheduler. For example, when the UE is allocated three time slots, as illustrated in FIG. 4A, the UE may decide to use only one of the allocated time slots (e.g., time slot 1) and the corresponding five channel codes allocated to the time slot 1. In this case, the time slots 2 and 3 are freed up or made available for IRAT measurement.

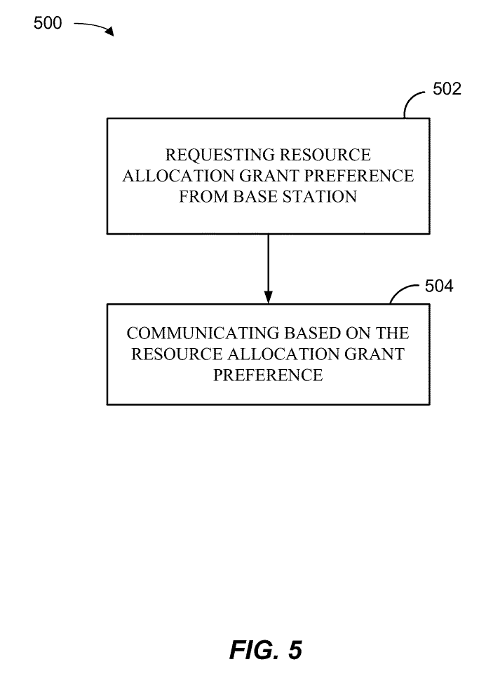

FIG. 5 shows a wireless communication method 500 according to one aspect of the disclosure. A UE may request a resource allocation grant preference from a base station, in which the request indicates a reduced number of time resources and an increased number of other resources, as shown in block 502. Next, in block 504, the UE communicates based on the resource allocation grant preference.

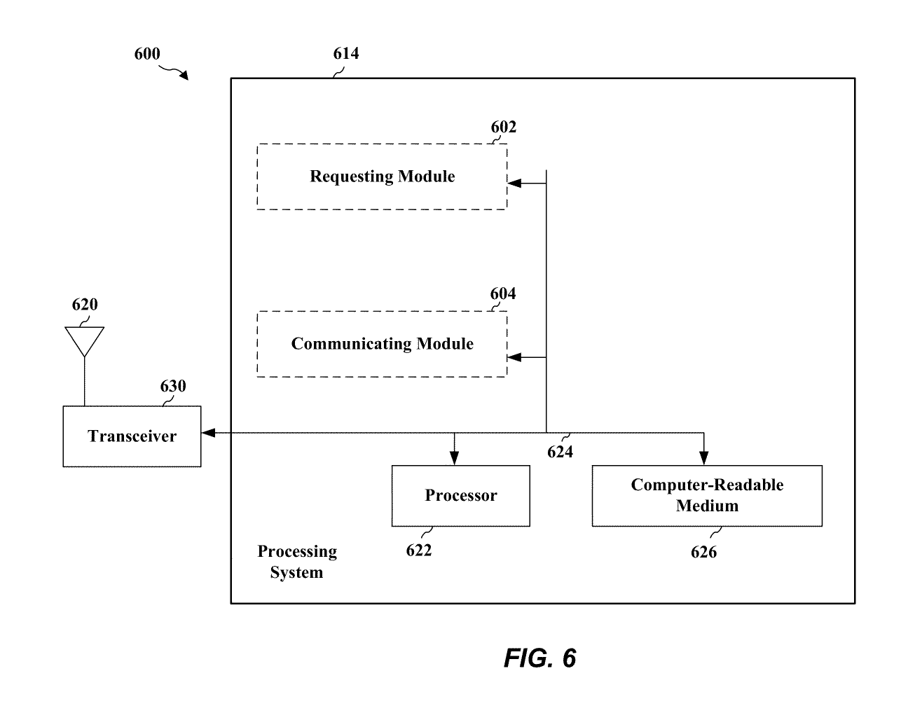

FIG. 6 is a diagram illustrating an example of a hardware implementation for an apparatus 600 employing a resource request system 614. The resource request system 614 may be implemented with a bus architecture, represented generally by the bus 624. The bus 624 may include any number of interconnecting buses and bridges depending on the specific application of the resource request system 614 and the overall design constraints. The bus 624 links together various circuits including one or more processors and/or hardware modules, represented by the processor 622 the modules 602 and 604, and the non-transitory computer-readable medium 626. The bus 624 may also link various other circuits such as timing sources, peripherals, voltage regulators, and power management circuits, which are well known in the art, and therefore, will not be described any further.

The apparatus includes a resource request system 614 coupled to a transceiver 630. The transceiver 630 is coupled to one or more antennas 620. The transceiver 630 enables communicating with various other apparatus over a transmission medium. The resource request system 614 includes a processor 622 coupled to a non-transitory computer-readable medium 626. The processor 622 is responsible for general processing, including the execution of software stored on the computer-readable medium 626. The software, when executed by the processor 622, causes the resource request system 614 to perform the various functions described for any particular apparatus. The computer-readable medium 626 may also be used for storing data that is manipulated by the processor 622 when executing software.

The resource request system 614 includes a requesting module 602 for requesting a resource allocation grant preference from a base station, in which the request indicates a reduced number of time resources and an increased number of other resources. The resource request system 614 includes a communicating module 604 for communicating based on the resource allocation grant preference. The modules may be software modules running in the processor 622, resident/stored in the computer readable medium 626, one or more hardware modules coupled to the processor 622, or some combination thereof. The resource request system 614 may be a component of the UE 350 and may include the memory 392, and/or the controller/processor 390.

In one configuration, an apparatus such as a UE is configured for wireless communication including means for requesting and means for communicating. In one aspect, the above means may be the antennas 352, the receiver 354, the channel processor 394, the receive frame processor 360, the receive processor 370, the transmitter 356, the transmit frame processor 382, the transmit processor 380, the controller/processor 390, the memory 392, the radio resource request module 391, the requesting module 602, the communicating module 604 and/or the resource request system 614 configured to perform the functions recited by the aforementioned means. In another aspect, the aforementioned means may be a module or any apparatus configured to perform the functions recited by the aforementioned means.

Several aspects of a telecommunications system has been presented with reference to TD-SCDMA systems. By way of example, various aspects of the present disclosure may be extended to other communications systems, such as Long Term Evolution (LTE) and Wideband Code Division Multiple Access (WCDMA). In LTE, the request may be for more subcarriers and fewer subframes, while in WCDMA the request may be for more Walsh codes and fewer transmission time intervals (TTI).

As those skilled in the art will readily appreciate, various aspects described throughout this disclosure may be extended to other telecommunication systems, network architectures and communication standards. By way of example, various aspects may be extended to other UMTS systems such as W-CDMA, High Speed Downlink Packet Access (HSDPA), High Speed Uplink Packet Access (HSUPA), High Speed Packet Access Plus (HSPA+) and TD-CDMA. Various aspects may also be extended to systems employing Long Term Evolution (LTE) (in FDD, TDD, or both modes), LTE-Advanced (LTE-A) (in FDD, TDD, or both modes), CDMA2000, Evolution-Data Optimized (EV-DO), Ultra Mobile Broadband (UMB), IEEE 802.11 (Wi-Fi), IEEE 802.16 (WiMAX), IEEE 802.20, Ultra-Wideband (UWB), Bluetooth, and/or other suitable systems. The actual telecommunication standard, network architecture, and/or communication standard employed will depend on the specific application and the overall design constraints imposed on the system.

Several processors have been described in connection with various apparatuses and methods. These processors may be implemented using electronic hardware, computer software, or any combination thereof. Whether such processors are implemented as hardware or software will depend upon the particular application and overall design constraints imposed on the system. By way of example, a processor, any portion of a processor, or any combination of processors presented in this disclosure may be implemented with a microprocessor, microcontroller, digital signal processor (DSP), a field-programmable gate array (FPGA), a programmable logic device (PLD), a state machine, gated logic, discrete hardware circuits, and other suitable processing components configured to perform the various functions described throughout this disclosure. The functionality of a processor, any portion of a processor, or any combination of processors presented in this disclosure may be implemented with software being executed by a microprocessor, microcontroller, DSP, or other suitable platform.

Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise. The software may reside on a non-transitory computer-readable medium. A computer-readable medium may include, by way of example, memory such as a magnetic storage device (e.g., hard disk, floppy disk, magnetic strip), an optical disk (e.g., compact disc (CD), digital versatile disc (DVD)), a smart card, a flash memory device (e.g., card, stick, key drive), random access memory (RAM), read only memory (ROM), programmable ROM (PROM), erasable PROM (EPROM), electrically erasable PROM (EEPROM), a register, or a removable disk. Although memory is shown separate from the processors in the various aspects presented throughout this disclosure, the memory may be internal to the processors (e.g., cache or register).

Computer-readable media may be embodied in a computer-program product. By way of example, a computer-program product may include a computer-readable medium in packaging materials. Those skilled in the art will recognize how best to implement the described functionality presented throughout this disclosure depending on the particular application and the overall design constraints imposed on the overall system.

It is to be understood that the specific order or hierarchy of steps in the methods disclosed is an illustration of exemplary processes. Based upon design preferences, it is understood that the specific order or hierarchy of steps in the methods may be rearranged. The accompanying method claims present elements of the various steps in a sample order, and are not meant to be limited to the specific order or hierarchy presented unless specifically recited therein.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language of the claims, wherein reference to an element in the singular is not intended to mean “one and only one” unless specifically so stated, but rather “one or more.” Unless specifically stated otherwise, the term “some” refers to one or more. A phrase referring to “at least one of” a list of items refers to any combination of those items, including single members. As an example, “at least one of: a, b, or c” is intended to cover: a; b; c; a and b; a and c; b and c; and a, b and c. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. §112, sixth paragraph, unless the element is expressly recited using the phrase “means for” or, in the case of a method claim, the element is recited using the phrase “step for.”

What is claimed is:

1. A method of wireless communication, comprising:
requesting a resource allocation grant preference from a base station, the request indicating a reduced number of time resources and an increased number of other resources.

2. The method of claim 1, in which the resource allocation grant preference comprises a downlink (DL) resource allocation grant preference.

3. The method of claim 2, in which the request is via a feedback channel.

4. The method of claim 1, in which the resource allocation grant preference comprises an uplink (UL) resource allocation grant preference.

5. The method of claim 4, in which the request is via scheduling information in schedule request channel if no grant or carried in an uplink HS data channel.

6. The method of claim 5, further comprising releasing the request when a signal quality exceeds a threshold.

7. The method of claim 1, in which the other resources comprise channel code resources.

8. The method of claim 1, in which the increased number of other resources comprises a larger frequency bandwidth within each subcarrier and/or more subcarriers.

9. The method of claim 8, in which the other resources comprise transmit power resources.

10. The method of claim 1, further comprising determining whether a signal quality is below a threshold value, and requesting when the signal quality is below the threshold value.

11. The method of claim 1, further comprising performing IRAT measurement during an idle period that is increased as result of a grant of the reduced number of time resources and the increased number of other resources.

12. An apparatus for wireless communication, comprising:
means for requesting a resource allocation grant preference from a base station, the request indicating a reduced number of time resources and an increased number of other resources; and
means for communicating based on the resource allocation grant preference.

13. An apparatus for wireless communication, comprising:
a memory; and
at least one processor coupled to the memory and configured:
to request a resource allocation grant preference from a base station, the request indicating a reduced number of time resources and an increased number of other resources.

14. The apparatus of claim 13, in which the resource allocation grant preference comprises a downlink (DL) resource allocation grant preference.

15. The apparatus of claim 14, in which the request is via a feedback channel.

16. The apparatus of claim 13, in which the resource allocation grant preference comprises an uplink (UL) resource allocation grant preference.

17. The apparatus of claim 16, in which the request is via scheduling information in schedule request channel if no grant or carried in an uplink HS data channel.

18. The apparatus of claim 17, in which the at least one processor is further configured to release the request when a signal quality exceeds a threshold.

19. The apparatus of claim 13, in which the other resources comprise channel code resources.

20. The apparatus of claim 13, in which the increased number of other resources comprises a larger frequency bandwidth within each subcarrier and/or more subcarriers.

21. The apparatus of claim 20, in which the other resources comprise transmit power resources.

22. The apparatus of claim 13, in which the at least one processor is further configured to determine whether a signal quality is below a threshold value, and in which the at least one processor is further configured to request by requesting when the signal quality is below the threshold value.

23. The apparatus of claim 13, in which the at least one processor is further configured to perform IRAT measurement during an idle period that is increased as result of a grant of the reduced number of time resources and the increased number of other resources.

24. A computer program product for wireless communications in a wireless network, comprising:
a non-transitory computer-readable medium having program code recorded thereon, the program code comprising:
code to request a resource allocation grant preference from a base station, the request indicating a reduced number of time resources and an increased number of other resources.
